(19) United States
(12) Patent Application Publication
(10) Pub. No.: US 2016/0236994 A1
(43) Pub. Date: Aug. 18, 2016

(54) PATTERNED ABRADABLE COATINGS AND METHODS FOR THE MANUFACTURE THEREOF

(71) Applicants: Rolls-Royce Corporation, Indianapolis, IN (US); Rolls-Royce North American Technologies, Inc., Indianapolis, IN (US)

(72) Inventors: Daniel Kent Vetters, Indianapolis, IN (US); Kang N. Lee, Zionsville, IN (US); Sean E. Landwehr, Avon, IN (US)

(21) Appl. No.: 15/046,281

(22) Filed: Feb. 17, 2016

Related U.S. Application Data
(60) Provisional application No. 62/117,295, filed on Feb. 17, 2015.

(51) Int. Cl. C04B 41/45

(52) U.S. Cl. CPC C04B 41/45

(57) ABSTRACT

An article includes an abradable ceramic coating with an arrangement of features selected such that the coating has a porosity of about 5% to about 90%.

This application claims the benefit of U.S. Provisional Application No. 62/117,295 filed Feb. 17, 2015, which is incorporated herein by reference in its entirety.

### BACKGROUND

Abradable coatings on flowpath surfaces above the moving metal blade tips in a turbine engine can reduce over tip leakage and improve efficiencies. For example, a rotating part can erode a portion of a fixed abradable coating applied on an adjacent stationary part to form a seal having a very close tolerance. In one example application, an abradable seal can be used to minimize the clearance between blade tips and an inner wall of an opposed shroud, which can reduce leakage or guide leakage flow of a working fluid, such as steam or air, across the blade tips, and enhance turbine efficiency.

### SUMMARY

As noted above, thermal barrier coat (TBC)/abradable coatings have been developed for traditional metal turbine shroud seals, which are also referred to herein as turbine blade track segments. However, ceramic matric composite (CMC) blade track segments require a ceramic environmental barrier coat (EBC)/TBC/abradable coating so the linear coefficients of thermal expansion (a) are better matched with the underlying substrate. During operation, a thermal mismatch results between a hot side of the abradable coating being scrubbed by a hot gas in the gas turbine flowpath and an opposed colder side of the abradable coating against the CMC segment. This thermal mismatch causes strains within the abradable coating as the hot side attempts to expand more than the cold side. High levels of these strains can cause the coating to crack and spall. Spallation can expose the underlying CMC component to excessive temperatures and can hurt turbine performance due to poorer efficiency due to increased tip clearance.

The exceeding low a of the CMC makes it difficult to find an abradable coating with a similar coefficient of thermal expansion. In addition, currently available ceramic coatings are not easy to apply and do not have a suitable balance of properties such as, for example, durability, life, TBC performance, and tip rub performance.

Porosity can be important in a traditional TBC/abradable coating for metal turbine blade track segments. Porosity reduces the thermal conductivity (improves TBC performance), while also improving tip rub performance. Porosity within the coating has traditionally been created while spraying the coating onto the component. However, only minimal levels of porosity can be created in a sprayed-on ceramic abradable coating, and such coatings are heavy, have high thermal conductivity, and poor tip rub performance.

In the present disclosure, in one embodiment porosity is created in a ceramic abradable coating by forming a pattern in a surface thereof

In one aspect, the present disclosure is directed to an article including an abradable ceramic coating, wherein at least portion of a major surface of the coating includes an array of depressions, wherein the depressions are arranged such that the coating has a porosity of about 5% to about 90%.

In another aspect, the present disclosure is directed to a method, including: forming an abradable ceramic coating on a CMC component; and machining a pattern of features into a surface of the abradable ceramic coating, wherein the features include an array of hemi spherically-shaped depressions.

In various embodiments, the ceramic abradable coatings described in this disclosure can have higher effective porosity compared to sprayed-on coatings, which can provide improved abradability. In various embodiments, the ceramic abradable coatings described in this disclosure can have higher density compared to sprayed-on coatings, which can provide improved erosion resistance.

Using spray techniques, it can be difficult to control the variation of porosity throughout the coating, which can lead to reduced minimum strength (less durable/life) and higher minimum thermal conductivity (poorer TBC performance). By forming a pattern into the surface, the variation in porosity can be more precisely controlled, which can result in improved durability/life, and better tip rub performance.

In various embodiments, the present disclosure provides a thicker abradable layer for a CMC component, which can increase the maximum tip rub capability of a blade track segment and can also provide increased thermal isolation (improved TBC performance). Compared to abradable coatings made with spray-coating techniques, the abradable coatings described herein can provide such enhanced properties at lower cost, and resulting parts can require reduced machining time to fit close tolerances.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1A is a schematic, overhead view of a pattern in a surface of an abradable ceramic coating.

FIG. 1B is a schematic, cross-sectional view of the coating of FIG. 1A.

FIGS. 1C-1E are schematic, overhead views of patterns in a surface of an abradable ceramic coating.

FIG. 1F is a perspective view of a portion of an abradable ceramic coating with a pattern in a surface thereof.

FIG. 2 is a schematic cross-sectional view of a tool used to create a pattern in a surface of a green ceramic article.

FIG. 3 is a schematic, cross-sectional view of a pattern of grooves in a surface of a patterned abradable coating.

FIGS. 4-8 are schematic, overhead views of patterns of blocks in a surface of a patterned abradable coating.

FIG. 9 is a schematic, partial side view of a rotating turbine engine component and an adjacent stationary component including patterned abradable coatings.

### DETAILED DESCRIPTION

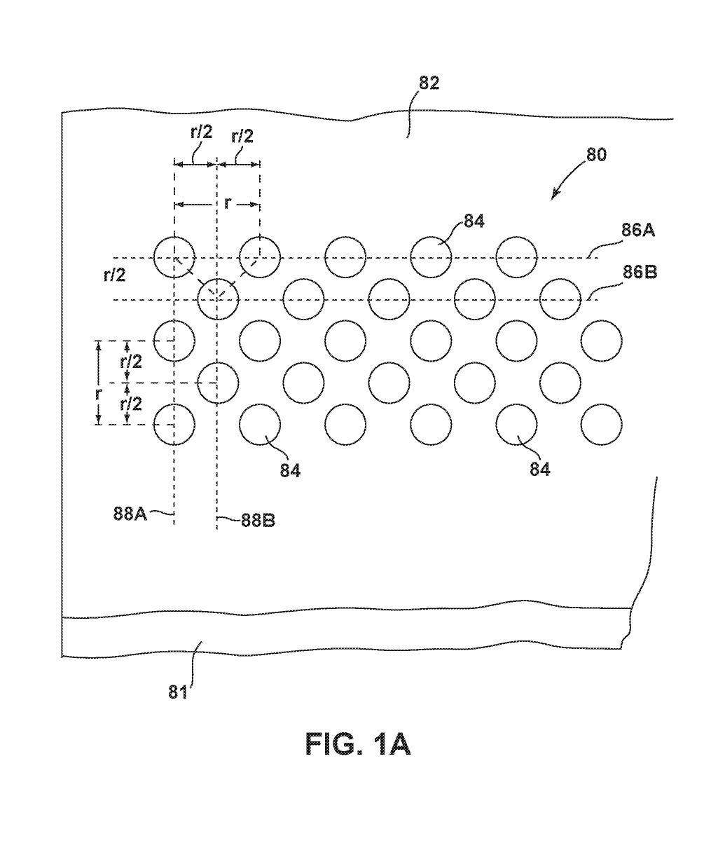

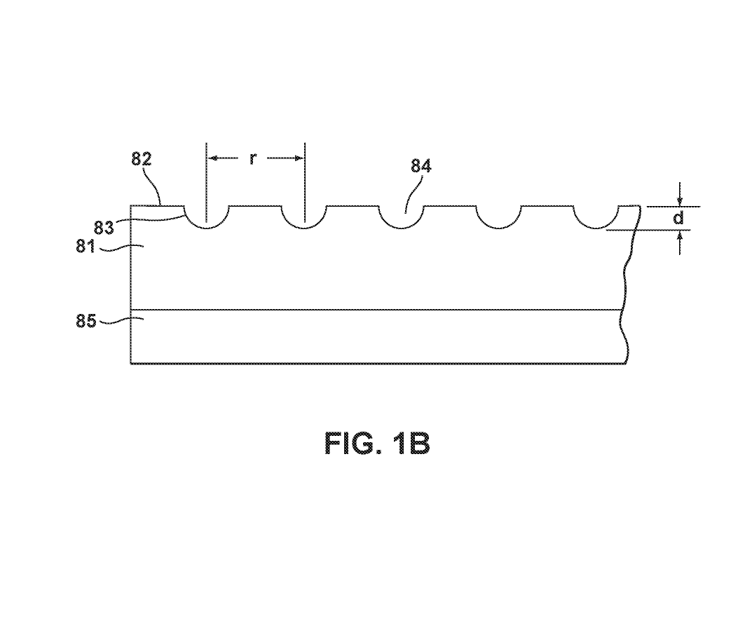

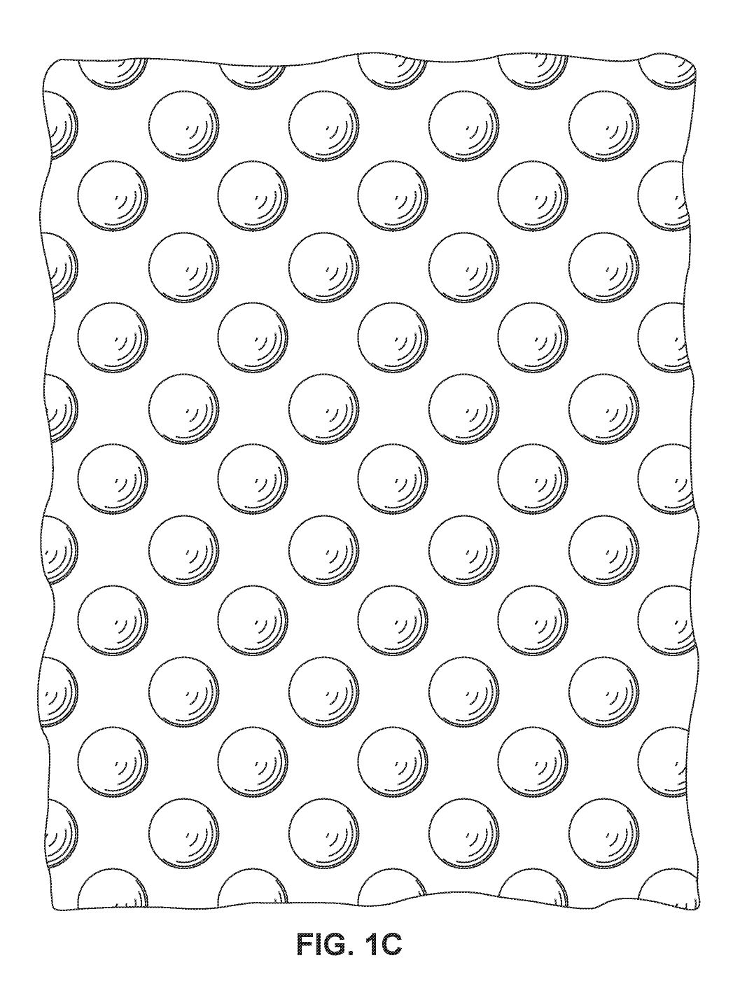

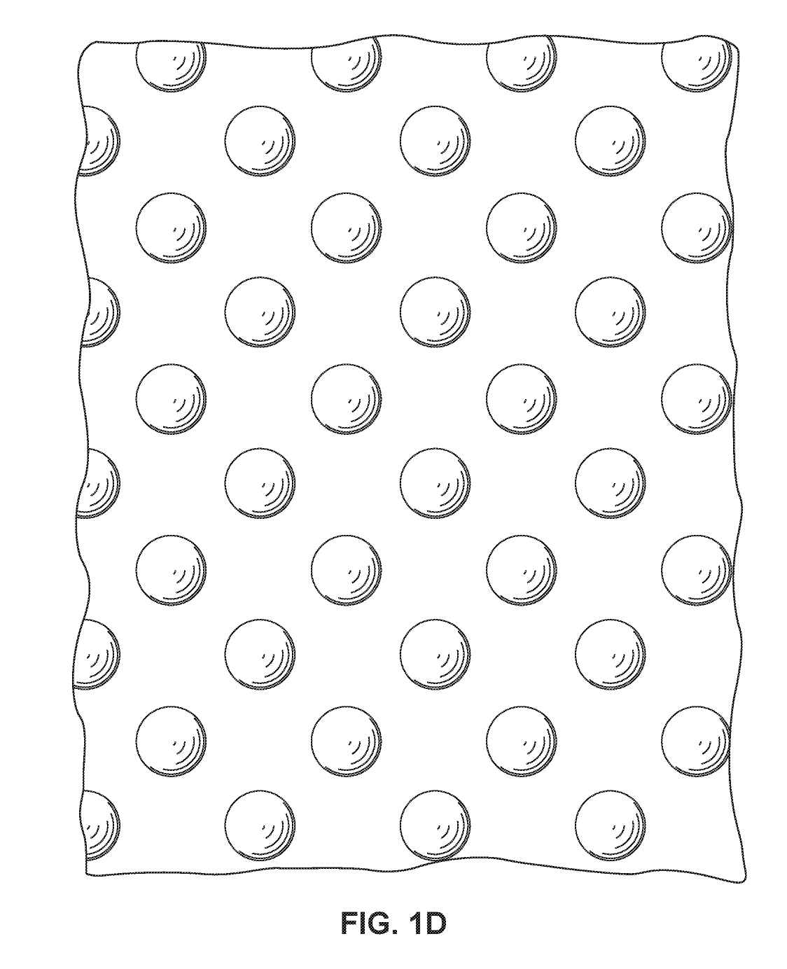

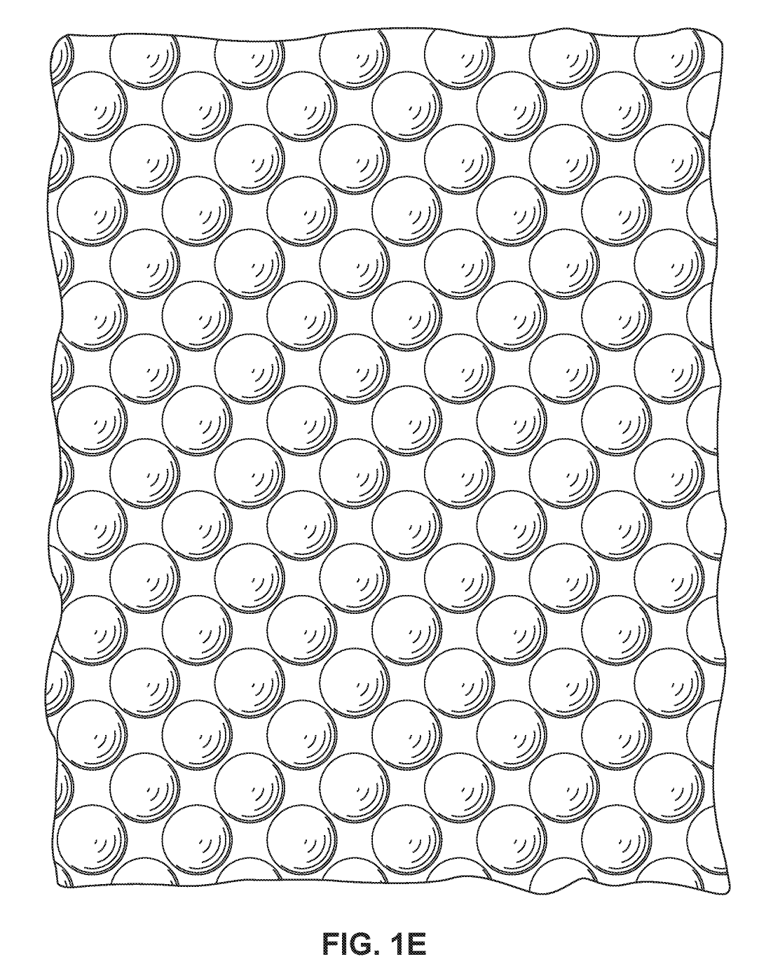

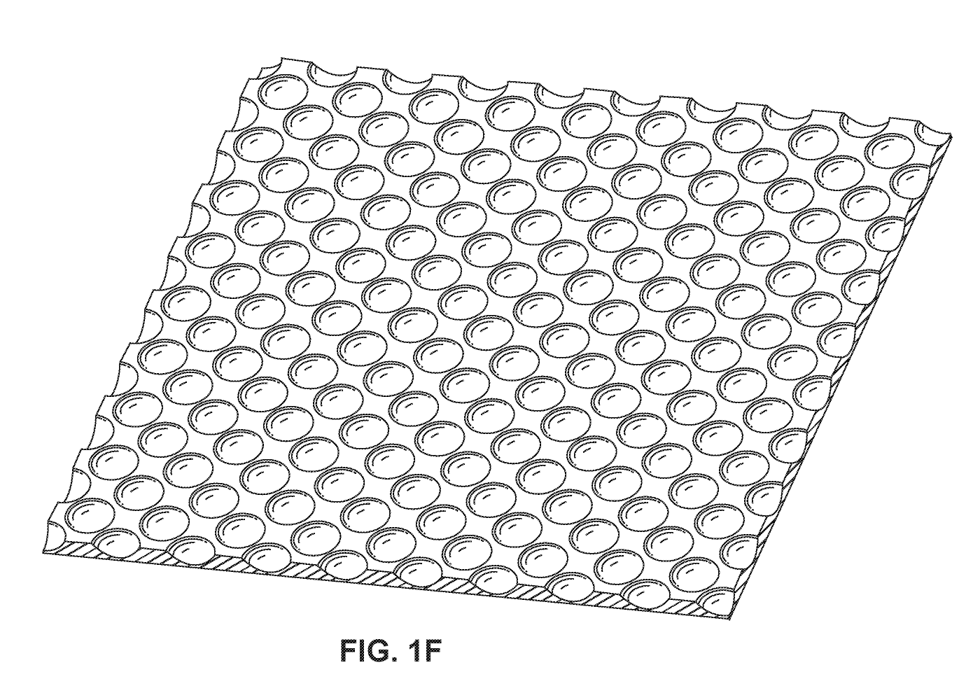

FIG. 1A is a schematic diagram of a non-limiting example embodiment of a pattern including an array of surface features 80 on at least a portion of a surface 82 of a ceramic abradable coating 81. The surface features may occupy all or a portion of the surface 82 of the coating 81.

In various non-limiting embodiments, the ceramic abradable coating 81 can include aluminum nitride, aluminum diboride, boron carbide, aluminum oxide, mullite, zirconium oxide, carbon, silicon carbide, silicon nitride, transition metal nitrides, transition metal borides, rare earth (RE) oxides, and mixtures and combinations thereof. In some embodiments, the ceramic abradable coating 81 includes at least one silicate, which in this application refers to a synthetic or naturally-occurring compound including silicon and oxygen. Suitable silicates include, but are not limited to, rare earth (RE) disilicates, RE monosilicates, barium strontium aluminum silicate, and mixtures and combinations thereof

Referring again to FIG. 1A, the array 80 includes a regular pattern of pocket-like depressions 84 that have shapes, sizes and patterns selected to control, for example, the porosity of the coating 81, the flow of a fluid over the surface 82, or both, while minimizing thermal stresses and stress concentrations in the coating 81. In the embodiment of FIG. 1A, the array 80 includes linear, parallel rows 86A, 86B and linear, parallel columns 88A, 88B of depressions 84. In rows 86A, 86B, the depressions 84 are a distance r apart, have a diameter x, and the depressions 84 of an adjacent row 86B are offset a distance r/2 relative to the depressions in the row 86A. In columns 88A, 88B, the depressions 84 are a distance r apart, and the depressions 84 of an adjacent column 88B are offset a distance r/2 relative to the depressions in the column 88A.

In various embodiments, the area of the individual depressions 84 should be sufficiently large, and the depressions should occupy a sufficiently large area of the surface 82, to resist thermal mismatches between opposed sides of the coating. This reduction in thermal mismatch can relieve thermal stresses within a hot surface of the coating, which in some embodiments can reduce coating spallation. Reduction in thermal mismatches can also allow a thicker coating to be applied on a substrate without resulting in excessive spallation and coating loss. In various embodiments, a thicker coating is desirable to increase maximum tip rub capability and provide enhanced thermal and/or environmental isolation.

In some embodiments, the area occupied by the individual depressions 84 should be sufficiently small and occupy a sufficiently small area of the surface 82 to maintain or improve turbine performance by controlling flow across a tip of a rotating part that engages the coating. In some embodiments, the size of the depressions is small relative to the thickness of the tip of the rotating part that engages the coating, which can maintain or improve turbine performance by restricting the flow across the tip of the blade via a series of fluid expansions and/or contractions.

In some embodiments, which are not intended to be limiting, the depressions 84 can be aligned to create solid, unbroken ridges that extend from one side of a component to an opposite side thereof. Such unbroken ridges can allow a path for a fluid to travel across a tip of a rotating component that engages the coating 81 (such as, for example, a blade tip), which in some embodiments can diminish turbine efficiency. In addition, while not wishing to be bound by any theory, presently available evidence indicates that unbroken ridges in the surface 82 of the coating 81 can lower thermal stress compared to a solid abradable coating, but in some embodiments coatings with long unbroken ridges can still have a thermal mismatch between opposed sides.

In a presently preferred embodiment, the depressions 84 should be alternating and relatively close together as shown in FIG. 1A, which minimizes the number of straight, unbroken ridges in the coating 81. Again, while not wishing to be bound by any theory, presently available evidence indicates that alternating patterns of closely-spaced depressions 84 that create fewer straight, unbroken ridges in the surface 82 can more effectively relieve thermal strains in the coating 81. In addition, in some embodiments alternating patterns of depressions 84 can minimize fluid leakage between the rotating component and the coating 81.

The shapes, sizes, depths and patterning of the depressions 84 can vary widely depending on the intended application. In some embodiments, the shapes, sizes (e.g. diameters), depths and arrangement of the depressions 84 may be the same over all or a portion of the surface 82, which is referred to herein as a regular array. In other embodiments, at least one of the shapes, sizes, depths and arrangement of the depressions 84 differs over all or a portion of the surface 82, which is referred to herein as an irregular array. In some irregular arrays, the shapes, sizes, depths and arrangement of the depressions varies randomly over the surface 82, or particular types of depressions may be used in different areas of the surface 82. In the embodiment of FIG. 1A, the depressions 84 are hemispherically-shaped dimples similar to those found on the surface of a golf ball, although shapes such as pyramidal, conical, or portions of geodesic spheres made from triangular, tetrahedral, icosahedral or octahedral elements are possible.

Referring to FIG. 1B, the cross-sectional profile 83 of the depressions 84 of FIG. 1A is semi-circular or parabolic, although other cross-sectional shapes are possible, such as square, rectangular, triangular or trapezoidal. Square or rectangular cross-sectional shapes create depressions with sharp sides and flat bottoms, which in some embodiments currently available evidence indicates would be less effective in minimizing thermal stresses in the coating 81, so depressions with gradually sloping sides are generally preferred. In some embodiments, depression shapes with sharp sides can also be more difficult to accurately and consistently manufacture at a reasonable cost.

To ensure performance and survivability of the coating 81, in some embodiments the depth d of the depressions 84 can be as deep as the maximum depth of the channel created when a rotating part (such as, for example, a turbine blade tip) engages the coating 81. In some embodiments the depressions 84 have a depth d extending all the way through the coating 81 to an underlying layer 85 on which the coating 81 is applied. In other embodiments the depth d of the depressions 84 should be less than the thickness of the coating 81 such that a solid area of the coating remains adjacent to the underlying layer 85 to act as a thermal and/or environmental barrier region. In various embodiments, the thickness of the abradable coating 81 is about 0.01 inches (0.25 mm) to about 0.125 inches (3.175 mm), and the depth d of the depressions 84 should not exceed the thickness of the abradable coating 81, but can be any thickness less than the thickness of the abradable coating 81.

In various embodiments that are merely included as examples are not intended to be limiting, a regular array of depressions that are each substantially spherical and have a depth d that that is the same as, or substantially similar to, their diameter x, have been found to be useful. For example, if x is the diameter of a depression at the surface of the abradable coating, and r is the spacing distance between adjacent depressions, (see FIG. 1A), in various embodiments the x/r ratio can be about 0.1 to about 1, or about 0.25 to about 0.75, or about 0.4 to about 0.7, or about 0.5 to about 0.67. In various embodiments that are not intended to be limiting, the diameter x of the depressions 84 is typically less than about 0.25 inches (6.35 mm).

FIG. 1C shows an example of a regular array of spherical depressions with an x/r ratio of about 0.5. At x/r ratios below 0.5, there are straight lines of surface material in four different directions. In another example, FIG. 1D shows a regular array of spherical depressions with an x/r ratio of about 0.4. At x/r ratios of greater than about 0.5, there are only thin, straight lines of material along the surface in two directions)(+/−45°. FIG. 1E shows a regular array of spherical depressions with an x/r ratio of about 0.67. Ratios of x/r greater than about 0.67 have minimal distances between depressions, or the depressions begin to intersect.

As the x/r ratio increases, greater effective porosity is created in the abradable coating layer including the depressions. Again, as an example that is not intended to be limiting, if the depressions have a depth d that is approximately equal to their distance apart r, the effective coating porosity at an x/r ratio of 0.4 was about 17%, at an x/r ratio of 0.5 was about 26%, and at an x/r ratio of about 0.67 was about 47%. In various embodiments, suitable porosities can be about 5% to about 90%, or about 15% to about 80%, or about 25% to about 75%, or about 25% to about 50%, or about 25% to about 45% (all values are ±1%).

Further, as shown in FIG. 1F, in some embodiments the array of depressions can extend all the way to an edge of a part, such that partial depressions remain near the edge. In some embodiments, this arrangement can further interrupt and/or eliminate the straight line of coating material at the edge.

Referring again to FIG. 1B, in various exemplary embodiments the layer 85 underlying the abradable coating layer 81 can be a bond coat layer, a thermal barrier coating layer, an environmental barrier coating (EBC) layer, or a CMC component.

Suitable examples environmental barrier coatings include, but are not limited to, mullite; glass ceramics such as barium strontium alumina silicate (BaOx-SrO1-x-Al2O₃-2SiO₂; BSAS), barium alumina silicate (BaO-Al₂O₃-2SiO₂; BAS), calcium alumina silicate (CaO-Al₂O₃-2SiO₂), strontium alumina silicate (SrO-Al₂O₃-2SiO₂; SAS), lithium alumina silicate (Li2O-Al₂O₃-2SiO₂; LAS) and magnesium alumina silicate (2MgO-2Al₂O₃-5SiO₂; MAS); rare earth silicates and the like.

Suitable examples of thermal barrier coatings, which may provide thermal insulation to the CMC substrate to lower the temperature experienced by the substrate, include, but are not limited to, insulative materials such as ceramic layers with zirconia or hafnia. The thermal barrier coating may optionally include other elements or compounds to modify a desired characteristic of the coating, such as, for example, phase stability, thermal conductivity, or the like. Exemplary additive elements or compounds include, for example, rare earth oxides.

In some embodiments, the surfaces of the abradable ceramic coatings including the depressions can optionally be treated (e.g., machined, polished, ground, cut, burnished, galled, drilled, or the like or a combination thereof) to achieve a desired dimension, surface morphology or chemistry.

The depressions 84 can be created in the surface 82 of the coating 81 by any suitable technique including, but not limited to, machining with a tool, laser sintering, water jet cutting, electrochemical machining (ECM), milling, and combinations thereof.

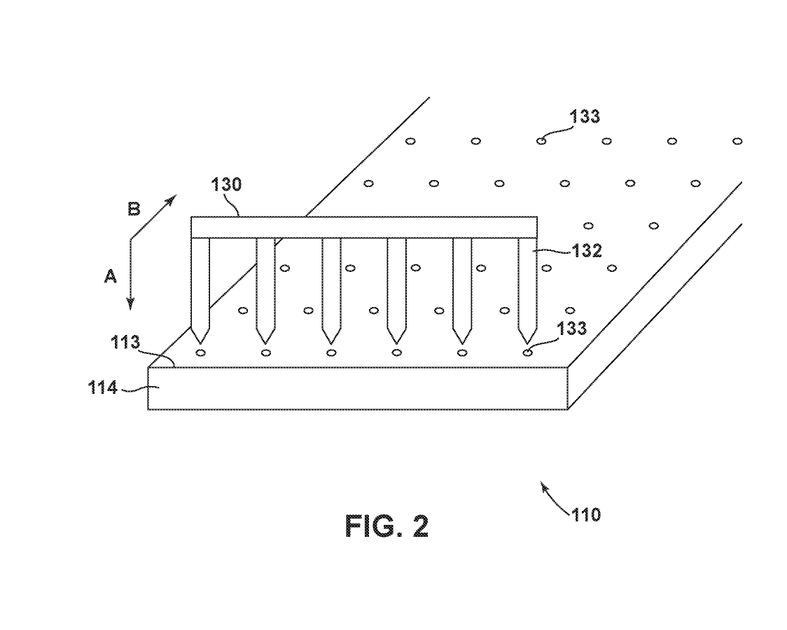

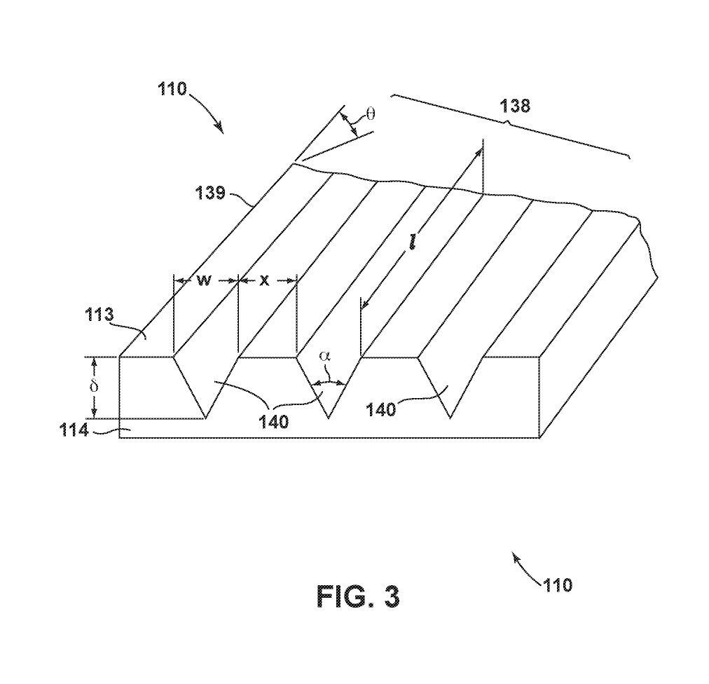

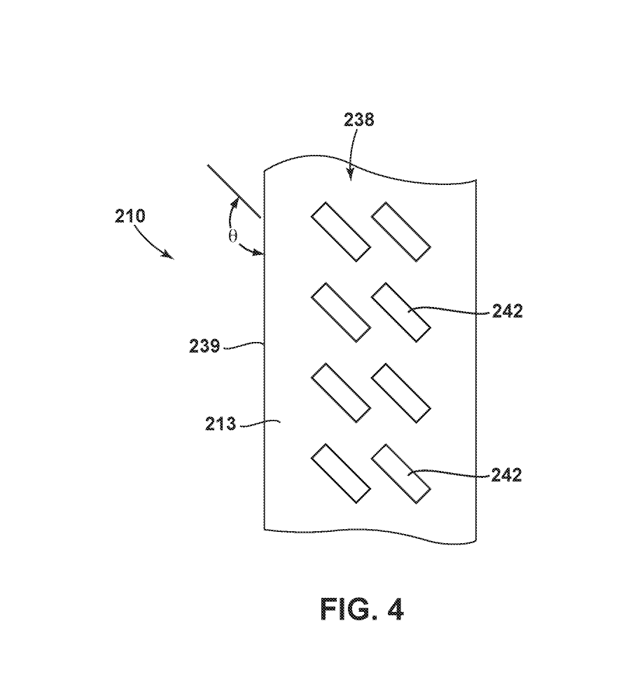

While the depressions 84 in FIGS. 1A-F are generally spherically shaped dimples, a wide variety of shaped depressions may be used. Examples include, but are not limited to, generally conically shaped depressions created by a pointed tool (FIG. 2), arrays and patterns of V-shaped grooves (FIG. 3), and various patterns such as shown in FIGS. 4-8 below.

Referring now to FIG. 2, in one embodiment a surface 113 of a ceramic layer 114 on a green ceramic article 110 can be machined by contacting the ceramic layer 114 with a tool 130.

In the schematic example of FIG. 2, the tool 130 includes punch elements 132 that, when moved in the direction of the arrow A, could create, for example, a regular or an irregular array of apertures 133 in all or a portion of the surface 113. The punch elements 132 may be configured to create apertures 133 with a wide variety of shapes, depths and patterns when observed from above including, for example, circles, squares, diamonds, triangles, trapezoids, and combinations thereof. The apertures 133 may also have a wide variety of cross-sectional shapes including, for example, circles, parabolas, triangles, squares, and combinations thereof. In various exemplary embodiments, the apertures 133 can be shaped like hemispheres, cones, pyramids, and combinations thereof. In some embodiments, these arrays of apertures can minimize thermal stresses and stress concentrations in all or a portion of the surface 113. Other non-mechanical techniques may be used to make the array of apertures 113 in the ceramic layer 114 including, for example, laser drilling or cutting, or chemical etching through a mask.

The green ceramic article 110 may be sintered using well known techniques to harden the machined ceramic layer 114 to form a patterned abradable coating. The resulting patterned abradable coating may optionally be further machined to modify the pattern thereon.

In another embodiment shown schematically in FIG. 3, the tool 130 of FIG. 2 could be moved over the surface 113 along the direction of the arrow B to create a pattern or array 138 of V-grooved channels 140 in all or a portion of the surface 113. In various embodiments, the grooves 140 could have a depth δ of about 0.01 inches (0.25 mm) to about 0.125 inches (3.175 mm), a width w of about 0.01 inches (0.25 mm) to about 0.125 inches (3.175 mm), a spacing x of about 0.01 inches (0.25 mm) to about 0.25 inch (6.35 mm), and any length l up to the entire length of the component. The angle α of the grooves 140 is generally less than about 135°. The grooves 140 can be oriented parallel to an edge 139 of the ceramic article 110, or can be oriented at an angle θ with respect to the edge 139, with θ ranging from about 0° to about 90°. The channels 140 could be straight as shown in FIG. 3, or in some embodiments could be curved or resemble wavy lines.

In various exemplary embodiments, a layer (not shown in FIG. 3) can underlie the abradable coating such as, for example, a bond coat layer, a thermal barrier coating layer, an environmental barrier coating (EBC) layer, or a CMC component.

FIGS. 2-3 are just examples of tooling and patterns that could be formed in an abradable coating. Additional examples of suitable machining techniques used to form patterns in abradable coatings include, but are not limited to, patterned rollers, laser sintering, water jet cutting, electrochemical machining (ECM), and combinations thereof.

In various embodiments, a tool could be utilized to create any type or combination of patterns in a surface of an abradable coating that could stop, redirect or otherwise control fluid flow adjacent that surface, adjust the porosity of the coating, or both. The pattern in the surface of the abradable coating can be continuous or discontinuous, regular or irregular, and can occupy all or a portion of the surface.

For example, as shown schematically in FIG. 4, the pattern 238 in all or a portion of a surface 213 of an abradable coating 210 can include staggered, spaced-apart block-like regions 242, and the blocks 242 can be oriented at an angle θ with respect to an edge 239.

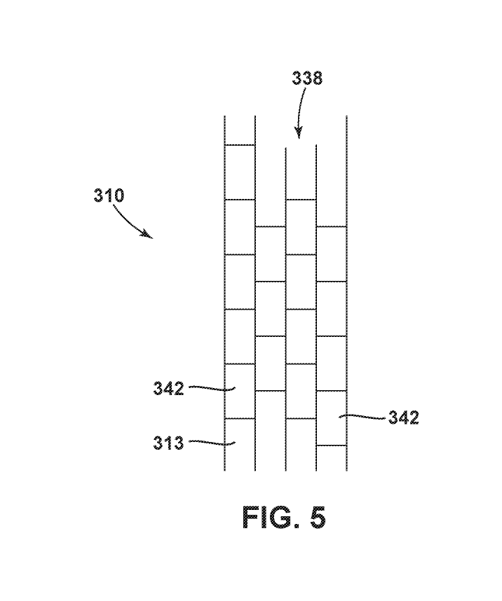

In another example shown in FIG. 5, the pattern 338 in the in all or a portion of a surface 313 of a patterned abradable coating 310 can include densely spaced, staggered block-like regions 342.

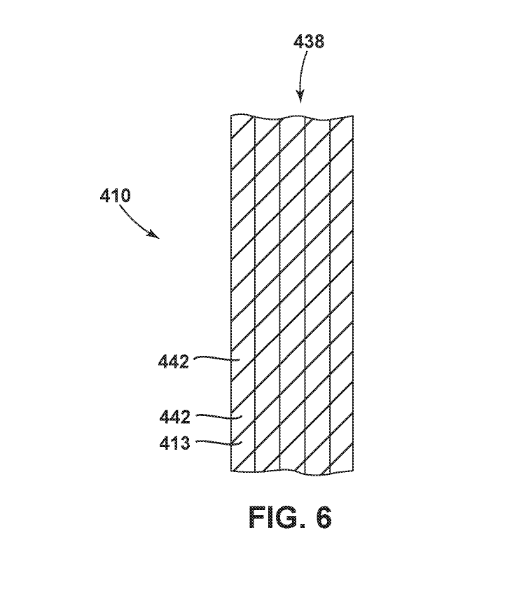

In yet another example shown in FIG. 6, the pattern 438 in the in all or a portion of a surface 413 of an abradable coating 410 can include diamond-shaped blocks 442.

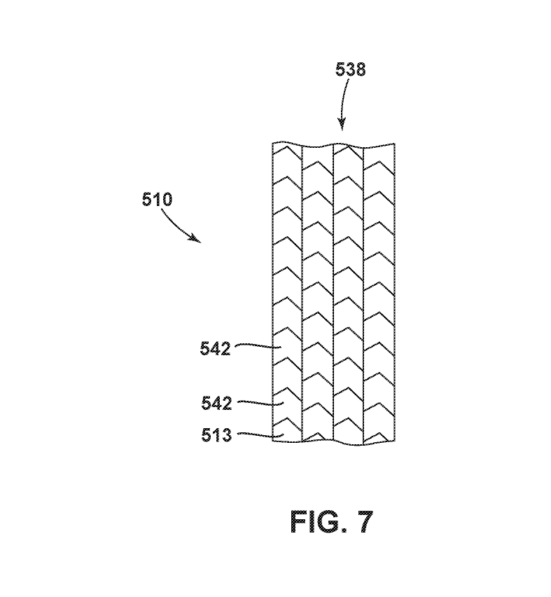

In yet another example shown in FIG. 7, the pattern 538 in the in all or a portion of a surface 513 of an abradable coating 510 can include chevron-shaped blocks 542.

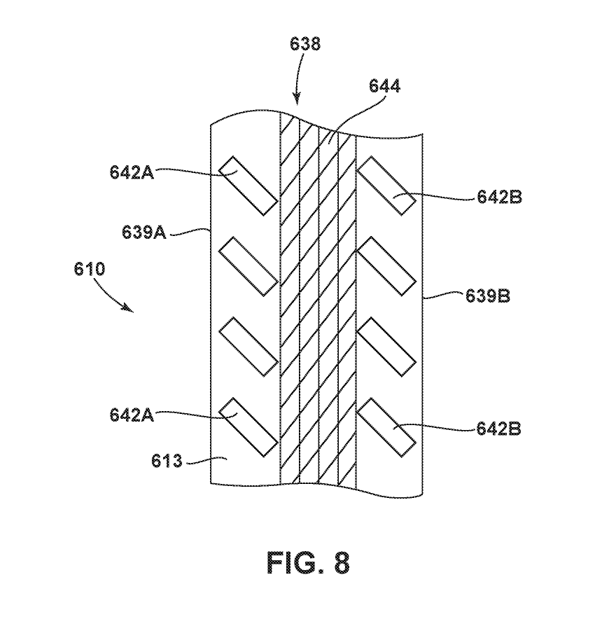

Many other complex patterns are possible, including honeycomb-like patterns and the like. Combinations of patterns can also be used. For example, in one embodiment shown in FIG. 8, the pattern 638 in the in all or a portion of a surface 613 of an abradable coating 610 can include a first arrangement of blocks 642A-642B along respective edges 639A-639B, and an arrangement of diamond-shaped blocks 644 between the blocks 642A-642B.

In each of the patterns shown in FIGS. 2-8, the surface features can protrude upward from the surface of the abradable coating to a height of about 0.01 inches (0.25 mm) to about 0.125 inches (3.175 mm), or can be depressed into the surface of the abradable coating at a depth of about 0.01 inches (0.25 mm) to about 0.125 inches (3.175 mm).

The patterned abradable coatings of the present disclosure can be used on any type of turbine engine components, both shrouded and un-shrouded. In these applications, the patterned abradable coating may produce any or all of the following effects: reduce swirling of the fluid over the surface, modify the direction of flow to enhance aerodynamic efficiency, control leakage flow, modify coating porosity, and the like.

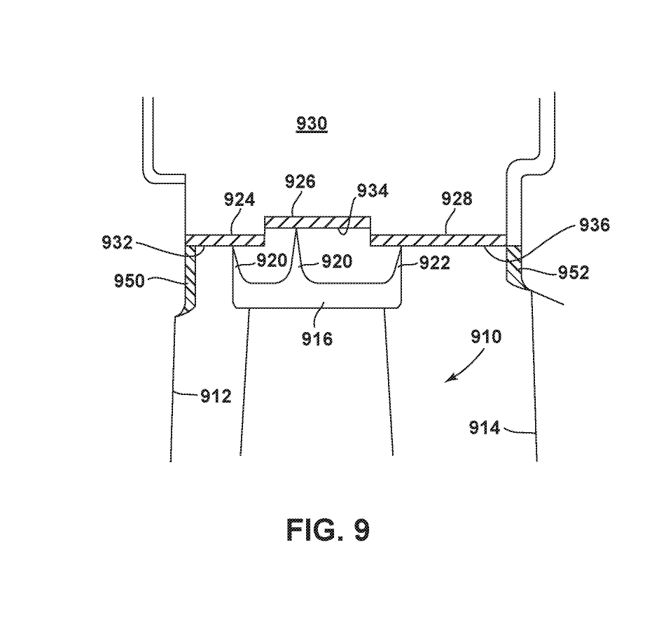

FIG. 9 provides a non-limiting example of how a patterned abradable coating may be used on a surface of a stationary turbine engine part adjacent to a rotatable turbine engine part to control fluid flow over the surface of the stationary part. In the non-limiting example of FIG. 9, a shrouded bucket 910 is mounted on a rotor wheel axially between a pair of upstream and downstream nozzle vanes 912, 914. The shrouded bucket 910 includes a tip shroud 916 formed with radially projecting axially spaced teeth 918, 920, 922. The teeth 918, 920, 922 are arranged to interact with patterned abradable coating regions 924, 926, 928 on a surrounding stator shroud 930. The regions 924, 926, 928 form abradable coating seals that may be applied to respective surfaces 932, 934, 936 of the stator shroud 930 to modify fluid flow over the surfaces 932, 934, 936. As another example, abradable ceramic coating regions 950, 952 may be applied on the nozzle vanes 912, 914.

Various embodiments of the invention have been described. These and other embodiments are within the scope of the following claims.

1. An article comprising an abradable ceramic coating, wherein at least portion of a major surface of the coating comprises an array of depressions, wherein the depressions are arranged such that the coating has a porosity of about 5% to about 90%.

2. The article of claim 1, wherein the array is regular.

3. The article of claim 1, wherein the array of depressions comprises at least one of: (a) linear, parallel rows of depressions; and (b) linear, parallel columns of depressions.

4. The article of claim 3, wherein each row of depressions in the array is offset with respect to an adjacent row of depressions, and wherein each column of depressions is offset with respect to an adjacent column of depressions.

5. The article of claim 3, wherein the depressions in a first row are a distance r apart, and the depressions in a second row adjacent to the first row are positioned a distance r/2 between the depressions in the first row.

6. The article of claim 1, wherein the depressions are hemispherically shaped.

7. The article of claim 1, wherein the depressions have a circular cross-sectional shape.

8. The article of claim 1, wherein the depressions have an elliptical cross-sectional shape.

9. The article of claim 1, wherein the depressions occupy a substantial portion of the area of the major surface.

10. The article of claim 1, wherein the ratio of the diameter of the depressions (x) to the distance between the depressions (r) is about 0.25 to about 0.75.

11. The article of claim 1, wherein the abradable coating is directly on a CMC substrate.

12. The article of claim 1, wherein the abradable coating overlies a second coating, and wherein the second coating is different from the abradable coating.

13. The article of claim 12, wherein the second coating comprises a bond coating.

14. A method, comprising:
forming an abradable ceramic coating on a CMC component;
machining an array of features into a surface of the abradable ceramic coating, wherein the features comprise an array of hemispherically-shaped depressions.

15. The method of claim 14, wherein the array of depressions comprises at least one of: (a) linear, parallel rows of depressions; and (b) linear, parallel columns of depressions.

16. The method of claim 15, wherein each row of depressions in the array is offset with respect to an adjacent row of depressions, and wherein each column of depressions is offset with respect to an adjacent column of depressions.

17. The method of claim 15, wherein the depressions in a first row are a distance r apart, and the depressions in a second row adjacent to the first row are positioned a distance r/2 between the depressions in the first row.

18. The method of claim 15, wherein the coating has a porosity of about 25% to about 45%.

19. The method of claim 15, wherein the ratio of a diameter of the depressions (x) to a distance between the depressions (r) is about 0.5 to about 0.67.
